(19) United States
(12) Patent Application Publication
(10) Pub. No.: US 2009/0179918 A1
(43) Pub. Date: Jul. 16, 2009

(54) Mirror processor for display device

(75) Inventors: Siao-Huei Lai, Taipei County (TW); Lung-Teng Hsu, Taipei-County (TW)

Correspondence Address: BACON & THOMAS, PLLC, 625 SLATERS LANE, FOURTH FLOOR, ALEXANDRIA, VA, 22314-1176, US

(73) Assignee: Tenx Technology Inc., Taipei County (TW)

(21) Appl. No.: 12/213,633

(22) Filed: Jun. 23, 2008

(30) Foreign Application Priority Data
Jan. 15, 2008 (TW) 97200901

(51) Int. Cl. G09G 5/00; G01S 5/00

(52) U.S. Cl. 345/629; 342/357.12

(57) ABSTRACT

The mirror processor for display device of this invention comprises: A first input interface to receive a first image; a second input interface to receive a second image; an image decoding unit to convert said first and second images into a digital format; a memory unit to temporarily store at least said digitized first image; and an image processing unit to mirror said second image to generate a mirror image of said second image, to obtain said digitized first image from said memory unit and to superpose said digitized first image and said mirror image of said second image to form a synthetic image.

### FIELD OF THE INVENTION

The present invention relates to a mirror processor for the display device, especially to a mirror processor for the display device that is able to mirror the image of the sub-frame image to be displayed in the display device.

### BACKGROUND OF THE INVENTION

In the field of the cartronics (the electronic products for the automobile), the parking sensor has become a necessary equipment for the automobile. The parking sensor provides the driver the limited information in the determination of the existence and the relative distance of peripheral objects adjacent to the vehicle. Although the information provided is helpful, it is not sufficient for every driver in making a correct judgment.

A new generation of the parking sensor provides the video information to the driver. A camera is provided at the rear window or at the rearview mirror of the vehicle to shoot the image at the rear of the vehicle and provide the images to a display device provided in the control panel of the vehicle. With the help of a radar detector the driver of the vehicle would have sufficient information to determine how to park the vehicle. Since the viewing angle of the driver and the view angle of the camera are reversed, the image perceived by the driver and the image captured by the camera are reversed in the X axis. Therefore, the image that the camera captures shall be mirror processed before it is provided to and displayed in the display device. Correct information is thus provided to the driver.

In the conventional mirror processing technology, a sequence controller is provided in the displaying panel. The sequence control provides to the images to be displayed a particular phase difference, whereby the images to be displayed in the display device are mirrored along the vertical axis of the image. The rear vision generated by the conventional technology is the mirrored images captured by the camera and other images to be displayed in the display device. For example, in a parking sensor that uses the display device of an on-vehicle DVD player as its display device, the rear vision captured by the camera of the parking sensor is displayed in a sub-frame in the display device of the DVD player. When the mirror processing function is activated, not only the rear visions captured by the camera but also the images of the program being played back in the DVD player are mirrored. The passengers will thus be disturbed.

In addition, in the conventional technology the mirror processor is not able to provide the mirrored images in high quality and in high speed. A novel mirror processor for the parking sensor that is able to provide correct mirrored images in higher quality and higher speed is thus desirable.

### OBJECTIVES OF THE INVENTION

The objective of the present invention is to provide a novel mirror processor for the display device, whereby correct mirrored images may be displayed in the displaying device.

Another objective of the invention is to provide a mirror processor for the display device that is able to display images in high quantity and high speed.

Another objective of the invention is to provide a mirror processor for the parking sensor that is able to display correct images in the display device.

Another objective of the invention is to provide a mirror processor for the parking sensor to display images in high quantity and high speed.

### SUMMARY OF THE INVENTION

According to the present invention a novel mirror processor for display device is provided. The mirror processor for display device provides a sub-frame image that has been mirror processed and a main frame image without the mirror effects. It may also provide a mirrored main frame image and a sub-frame image without the mirror effects. Pursuant to the needs of the user, it may also provide the mirrored images of both the main frame and the sub-frame to the display device. In addition, the mirror processor for display device of the present invention provides the images to the display device in higher quality and at a higher speed, if compared with the conventional sequence controller technology.

The mirror processor for display device of this invention comprises a first input interface, a second input interface, an image decoder unit, a memory unit and an image processing unit. The invented mirror processor generates the picture-in-picture (PIP) images to the display device, with at least one of the main frame image and the sub-frame image being mirrored.

In the mirror processor for display device of this invention, the sequence controller used in the conventional art is not necessary. The image processing unit of the present invention serves to mirror the images to be displayed. In addition, when a plurality of sub-frames is to be displayed, the mirror effects may be applied to the selected sub-frames.

When using the invented mirror processor for display device to produce the mirrored images, the first input interface firstly receives a first image and the second input interface receives a second image. The image decoding unit then converts the first and second images into the digital format. The first image is stored in the memory unit. The second image is mirror processed to generate a mirrored second image. The first image is read out from the memory. The first image and the mirrored second image are overlaid to generate a synthetic image. The synthetic image is then provided to the display device.

The image processing unit of the present invention preferably comprises a horizontally mirroring processing unit, which mirrors the second image along its vertical axis. In addition, the image processing unit may also be a vertically mirroring processing unit that mirrors the second image along its horizontal axis.

The image processing unit of the invention comprises a mirror image generating circuit, a control circuit and an image superposing circuit. The mirror image generating circuit mirror processes the digitalized second image to generate a mirrored second image. The control circuit stores the first image in the memory unit or restores the fist image into the image processing unit. The image superposing circuit superposes the first image and the second image. The control circuit may comprise a scaling circuit and an image penetration circuit. The scaling circuit scales the size of the second image or the first image, after the first image is restored from the memory unit. The image penetration circuit supports the image superposing circuit in providing the semitransparent displaying effect for the first image or the mirrored second image and generating the frame for the first image or the mirrored second image.

The mirror processor for display device of this invention may further comprise an output interface to output the synthetic image to the display unit. The output interface preferably comprises an RGB output display interface.

The mirror processor for display device of this invention may further comprise an image sensor, to capture the peripheral images as the first image and to provide the captured images to the first input interface. The mirror processor for display device of the invention may further comprise a GPS receiver to receive the satellite geographic positioning information from the GPS and to generate the GPS images as the first image. The GPS receiver may provide the generated GPS images to the first input interface. The mirror processor for display device of the invention may further comprise a multimedia module to receive multimedia images as the first image and to provide the received multimedia images to the first input interface.

The first and second input interfaces suited in the present invention may be the S-video interface, the DVBS interface, the YCbCr interface or the YPbPr interface, respectively. The display unit suited in the present invention may be the liquid crystal display panel or the plasma display panel. The image processing unit of the present invention preferably comprises a selective image mirror processing unit that selectively mirrors the first image or the second image or their combination.

The mirror processor for display device of this invention may further comprise a third input interface, or a third input interface and a fourth input interface. The third input interface may receive a third image and the four input interface receives a fourth image. In such a case, the image processing unit may be a selective image mirror processing unit that selectively mirrors the first image, the second image, the third image or the fourth image, or their combinations.

As described above, the mirror processor for display device of this invention may provide the mirror-processed images to all kinds of displaying device, including the displaying panels where the sequence controller is used.

These and other objectives and advantages of the present invention may be clearly understood from the detailed description by referring to the following drawings.

### BRIEF DESCRIPTION OF THE DRAWINGS

FIG. 1 shows the block diagram of the first embodiment in the mirror processor for display device of this invention.

FIG. 2 shows the block diagram of the second embodiment in the mirror processor for display device of this invention.

### DETAILED DESCRIPTION OF THE INVENTION

The preferred embodiments of the mirror processor for display device of this invention will be described as illustration in the followings. It shall be understood that other changes, deviations and adaptations may be made by those skilled in the art without departing from the scope of the present invention.

### Embodiment I

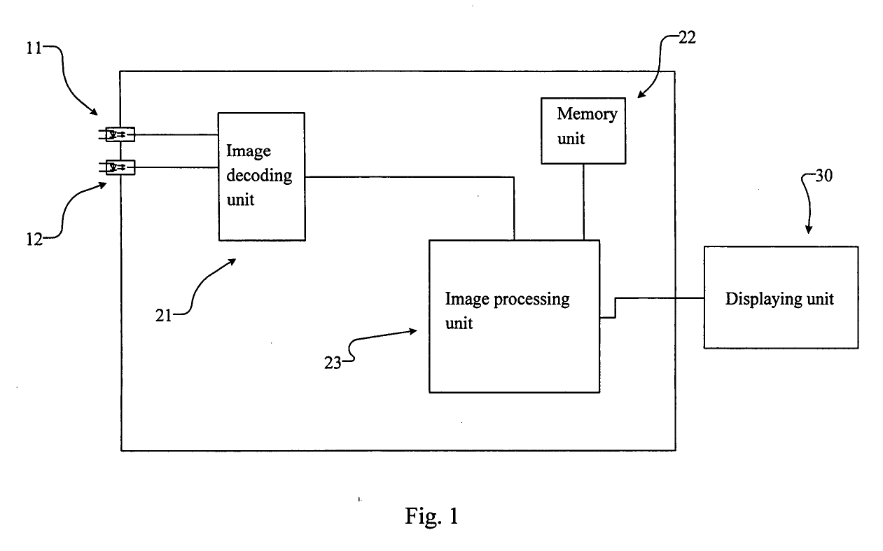

FIG. 1 shows the block diagram of the first embodiment in the mirror processor for display device of this invention. As shown in this figure, the mirror processor for display device of this invention comprises: A first input interface 11, a second input interface 12, an image decoder unit 21, a memory unit 22 and an image processing unit 23 and is in connection with a displaying unit 30.

In the above circuits, the first input interface 11 receives the first image and the second input interface 12 receives the second image. The first and second images are then provided to the image decoding unit 21, to be converted into the digital format by the image decoding unit 21.

After the digitization of the first and second images, the first image is stored in the memory unit 22 temporarily, until the second image is mirror processed. In other words, the memory unit 22 is a buffer to store the digitized first image.

On the other hand, the second image is mirror processed in the image processing unit 23. The image processing unit 23 mirrors the digitized second image to generate a mirrored image for the second image. Thereafter, the first image is obtained from the memory unit 22 and the image processing unit 23 superposes the first image and the second image to form a synthetic image. The synthetic image is provided to the displaying unit 30 for display.

In this embodiment, the image processing unit 23 selectively mirrors the first image or the second image, or their combination. In addition, the image processing unit 23 may mirror the images horizontally or vertically. In conducting the horizontal mirroring, the image is mirrored along its vertical axis. In conducting the vertical mirroring, the image is mirrored along its horizontal axis. It is also possible to mirror the image in the horizontal direction and in the vertical direction simultaneously.

The first input interface 11 and the second input interface 12 are preferably an S-video interface, a CVBS interface, a YCbCr interface or a YPbPr interface, respectively. In this embodiment, the first input interface 11 is an S-video interface and the second input interface 12 is a CVBS interface. In addition, the displaying unit 30 is preferably a liquid crystal display panel or a plasma display panel. In this example, the displaying unit 30 is a liquid crystal display panel.

### Embodiment II

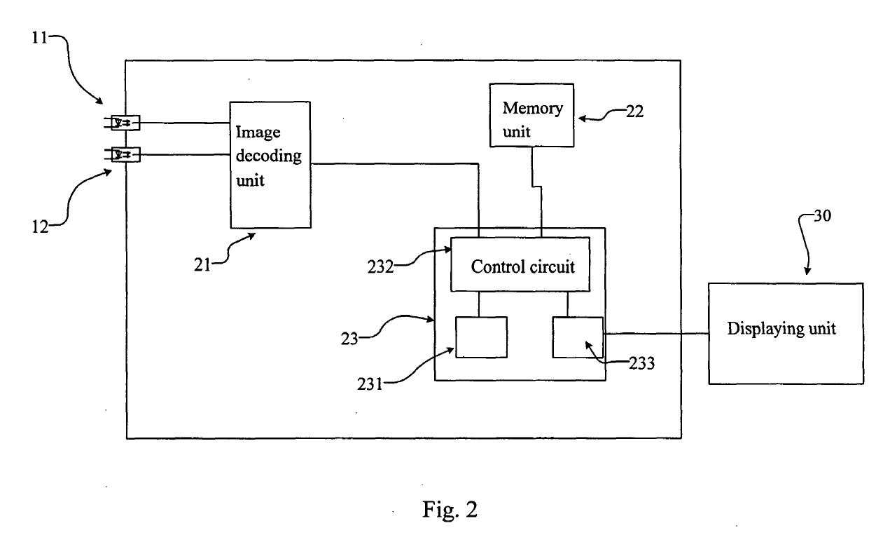

FIG. 2 shows the block diagram of the second embodiment in the mirror processor for display device of this invention. In this figure, the elements that are the same as those in FIG. 1 are labeled with the same reference numbers. As shown in this figure, the structure of the mirror processor for display device in this Embodiment II is basically the same as that of the Embodiment I. The major differences are in that the image processing unit 23 in this Embodiment II comprises a mirror image generating circuit 231, a control circuit 232 and an image superposing circuit 233. Also as shown in this figure, the mirror image generating circuit 231 mirrors the digitalized second image to generate a mirror image for the second image. The control circuit 232 stores the first image in the memory unit 22 and restores the first image into the image processing unit 23. The image superposing circuit 233 superposes the first image and the mirror image of the second image.

In application the above-said control circuit may include a scaling circuit and an image penetration circuit. In them, the scaling circuit scales the size of the mirror image of the second image or the restored first image. The image penetration circuit provides its supports to the image superposing circuit by defining the first image or the mirror image of the second image as semitransparent and generating the frame for the first image or the mirror image of the second image.

The mirror processor for display device of this invention may further comprise an output interface 24. The output interface 24 is in connection with the image processing unit 23, to receive the synthetic images from the image processing unit 23 and to provide the synthetic images to the displaying unit 30. The output interface is preferably an RGB output display interface.

The mirror image generator of the present invention may further comprise an image sensor and a digital multimedia module (both not shown). The digital multimedia module is provided in connection with the first input interface 11 and the image sensor is in connection with the second input interface 12. The digital multimedia module receives multimedia images and provides the received multimedia images to the first input interface 11 as the first image. The image sensor captures the peripheral images and provided the captured images to the second input interface 12 as the second image. The image decoding unit 21 converts the first image and the second image into the digital format. The image processing unit 23 then mirrors the second image and, with the help of the memory unit 22, superposes the first image and the mirrored second image to form a synthetic image. The synthetic image is then displayed in the liquid crystal display panel 30.

The design of the Embodiment II may be used as the parking sensor in the vehicle. In other words, the image sensor may be provided in the rear window or the rearview mirror of the vehicle, to capture the rear vision of the vehicle. The images so captured are then displayed in the sub-frame of the liquid crystal display panel at the displaying panel of the driver seat. The display device displays both the multimedia image and the rear vision image at the same time. The image sensor is preferably a CMOS image sensing component, a CCD image sensing component or a camera.

The mirror processor for display device may further include a GPS receiver (not shown), to receive the satellite positioning information and to generate the GPS images according to the received information. The GPS images are provided to the first input interface 11 as the first image.

The number of the image data input interface is not limited to 2. It is possible to use 3 or more image input interfaces. In that case, the image processing unit 23 is preferably a selective mirror processing unit, to selectively mirror the first image, the second image or the third image, or their combinations.

The mirror processor for display device of this invention may display the processed images in all kinds of displaying panels, including the displaying panels where the conventional sequence controller is used.

The mirror processor for display device does not only support the parking sensor, it may be used in any application where the mirror image is needed. For example, in the construction site the mirror processor of this invention can help to capture the 360 degree vision of the crane. In the loading and unloading of cargo in a truck, the invented mirror processor helps the truck driver to capture the rear vision of the truck.

As the present invention has been shown and described with reference to preferred embodiments thereof, those skilled in the art will recognize that the above and other changes may be made therein without departing form the spirit and scope of the invention.

What is claimed is:

1. A mirror processor for display device, comprising:
a first input interface to receive a first image;
a second input interface to receive a second image;
an image decoding unit to convert said first and second images into a digital format;
a memory unit to temporarily store at least said digitized first image; and
an image processing unit to mirror said second image to generate a mirror image of said second image, to obtain said digitized first image from said memory unit, and to superpose said digitized first image and said mirror image of said second image to form a synthetic image.

2. The mirror processor for display device according to claim 1, wherein said image processing unit mirrors said digitized second image along its vertical axis.

3. The mirror processor for display device according to claim 1, wherein said image processing unit mirrors said digitized second image along its horizontal axis.

4. The mirror processor for display device according to claim 1, wherein said image processing unit comprises a mirror image generating circuit, a control circuit and an image superposing circuit; wherein said mirror image generating circuit mirrors said digitized second image to generate a mirror image of said second image; said control circuit stores said digitized image in said memory unit and restores said digitized first image into said image processing unit; and said image superposing circuit superposes said digitized first image and said mirror image of said second image to form said synthetic image.

5. The mirror processor for display device according to claim 1, wherein said control circuit comprises a scaling circuit and an image penetration circuit; wherein said scaling circuit scales the size of said second image and wherein said image penetration circuit defines said digitized first image or said mirror image of said second image as semitransparent.

6. The mirror processor for display device according to claim 1, further comprising an output interface to output said synthetic image to a display unit.

7. The mirror processor for display device according to claim 6, wherein said output interface is an RBG output display interface.

8. The mirror processor for display device according to claim 1, wherein said first input interface is one selected from the group consisted of the S-video interface, the DVBS interface, the YCbCr interface or the YPbPr interface.

9. The mirror processor for display device according to claim 1, wherein said second input interface is one selected from the group consisted of the S-video interface, the DVBS interface, the YCbCr interface or the YPbPr interface.

10. The mirror processor for display device according to claim 1, further comprising an image sensing element to capture peripheral images and to provide said captured images to said second input interface as said second image.

11. The mirror processor for display device according to claim 10, further comprising a digital multimedia module to receive multimedia images and to provide said received images to said first input interface as said first image.

12. The mirror processor for display device according to claim 1, further comprising a GPS receiver to receive GPS information, to generate GPS images according to said received GPS information and to provide said generated images to said first input interface as said first image.
